(19) United States
(12) Patent Application Publication
(10) Pub. No.: US 2025/0137858 A1
(43) Pub. Date: May 1, 2025

(54) MEASUREMENT SYSTEM COMPRISING AN OPTICAL FIBER PROVIDED WITH AT LEAST ONE BRAGG GRATING FOR MEASURING DYNAMIC DEFORMATION, AIRCRAFT AND METHOD

(71) Applicant: AIRBUS HELICOPTERS, Marignane Cedex (FR)

(72) Inventors: Maxime ASSELIN, Marseille (FR); Pascal N'GUYEN, Colombes (FR); Romain ORTALI, Marignane (FR)

(73) Assignee: AIRBUS HELICOPTERS, Marignane Cedex (FR)

(21) Appl. No.: 18/774,436

(22) Filed: Jul. 16, 2024

(30) Foreign Application Priority Data
Oct. 25, 2023 (FR) 2311559

(51) Int. Cl. G01L 1/24; G01L 11/02

(52) U.S. Cl. CPC G01L 1/246; G01L 11/025

(57) ABSTRACT

A measurement system for measuring a dynamic deformation of an object, the measurement system comprising an optical fiber, the optical fiber extending at least partially into a tube that is configured to be secured to the object, the optical fiber having a measurement sector that is able to move inside the tube, the measurement sector comprising at least one Bragg grating. The measurement system comprises a non-Newtonian fluid filling at least one chamber delimited by the tube, the measurement sector extending into the at least one chamber, the non-Newtonian fluid being in contact with the tube and the measurement sector.

### CROSS REFERENCE TO RELATED APPLICATIONS

This application claims priority to French Patent Application No. FR 23 11559 filed on Oct. 25, 2023, the disclosure of which is incorporated in its entirety by reference herein.

### TECHNICAL FIELD

The present disclosure relates to a measurement system comprising an optical fiber provided with at least one Bragg grating for measuring the dynamic deformation of an object, an aircraft provided with such a measurement system, and a method.

### BACKGROUND

Various measurement systems are known for assessing the deformations of an object.

A known measurement system comprises an optical fiber having at least one Bragg grating. This system comprises an optical fiber provided with a core for guiding an optical signal, a cladding that covers the core and that has the function, in particular, of containing the light waves in the core, and a coating that covers the cladding.

This known measurement system also comprises at least one Bragg grating provided in the core. Each Bragg grating reflects only one part of the light having a particular wavelength. The light rays of the non-reflected light spectrum continue their journey along the core of the optical fiber.

The wavelength of this reflected light depends on the product of the pitch of the Bragg grating and the refractive index of the core of the optical fiber. The refractive index and the pitch themselves depend on the outside temperature and the deformation of the optical fiber.

Therefore, a modification in the wavelength of the reflected light may lead to a modification in the temperature and/or deformation of the optical fiber.

A measuring instrument referred to as an “interrogator” can be used to assess a temperature or deformation based on the reflected light.

In order to assess the deformation of an object with such a measurement system, the optical fiber is secured to this object. Deformation of the object causes the optical fiber to become deformed, thus modifying the wavelength of the reflected light. In order to optimize the measurements taking the temperature into account, the measurements can be taken at a constant temperature and/or a temperature measurement can be carried out in parallel, using another Bragg grating or a thermocouple, for example.

This technology allows an interrogator to assess total deformation, but not to distinguish between static deformation and dynamic deformation of the object. However, it may be helpful to assess the dynamic deformation of an object, for example in order to evaluate the service life of a dynamically deformable member such as a blade of a helicopter rotor.

Document EP 0892250 B1 does not provide a solution to this problem, describing an optical fiber comprising a Bragg grating at its end, this end being surrounded by a plug with a low Young's modulus in order to obtain reflected light with a wavelength that is essentially a function of the temperature.

Document FR 2946140 B1 is also far removed from this problem, relating to a Bragg grating optical fiber hydrophone.

Document EP 2507605 B1 describes a bearing comprising a ring provided with a groove, and a Bragg grating optical fiber placed inside the groove.

Document FR 2909446 B1 describes a device for measuring the mechanical deformations of a profile section, this device comprising at least one optical fiber sensor with two Bragg gratings in a cross.

Document US 2015/049981 A1 describes a measurement system comprising a tube and an optical fiber arranged in the tube. A buffer layer may be interposed between the optical fiber and the tube. The buffer layer may comprise a material belonging to the class of non-Newtonian fluids.

Document US 2002/041724 A1 is far removed from the technical field of the disclosure, relating to the measurement of body fluids.

### SUMMARY

An object of the present disclosure is thus to propose measurement system an innovative for measuring dynamic deformations, for example dynamic deformations of an aircraft rotor blade.

The disclosure therefore relates to a measurement system for measuring a dynamic deformation of an object, the measurement system comprising an optical fiber, the optical fiber extending at least partially into a tube that is configured to be secured to said object, the optical fiber having a measurement sector that is able to move inside the tube, the measurement sector comprising at least one Bragg grating.

This measurement system comprises a non-Newtonian fluid filling at least one chamber delimited by the tube, the measurement sector extending into the at least one chamber, the non-Newtonian fluid being in contact with the tube and the measurement sector.

The measurement sector can move in relation to the tube, by means of a mechanical connection. Such an arrangement is sometimes described as a “loose” arrangement.

A non-Newtonian fluid has a viscosity that varies depending on the force to which it is subjected. According to the disclosure, the greater the mechanical stress applied to the non-Newtonian fluid, the more the non-Newtonian fluid tends to behave like a solid and therefore tends to rigidly attach the measurement sector and the tube together.

For example, the non-Newtonian fluid may be a shear-thickening fluid or a viscoelastic fluid, or indeed a molten polymer.

For example, the non-Newtonian fluid may be a shear-thickening fluid comprising a liquid containing solid particles different from the liquid. Therefore, when a force is applied to the shear-thickening fluid, the particles present in the liquid group together and bind to each other, resulting in an orderly organization of the particles as in the case of water in its solid state. When the force is removed, the liquid molecules return to their positions between the particles. For example, the non-Newtonian fluid comprises a mixture of cornstarch and water.

Therefore, deformation of the object results in deformation of the tube because the tube is rigidly attached to this object. On the other hand, the measurement sector is encapsulated in the tube while still being able to move within the tube.

When static deformation occurs, the viscosity of the non-Newtonian fluid is low. The tube moves in relation to the measurement sector of the optical fiber. The optical fiber is then not deformed. The wavelength of the light reflected by each Bragg grating then does not vary or varies little.

Conversely, when dynamic deformation occurs, the viscosity of the non-Newtonian fluid increases. The deformation of the tube causes deformation of the measurement sector, via the non-Newtonian fluid. The wavelength of the light reflected by at least one Bragg grating is then modified. The variation in deformation measured with an interrogator is then a reflection of the dynamic deformation that has occurred.

The non-Newtonian fluid therefore makes it possible to estimate dynamic deformation, rather than simple deformation with no way of concluding whether this deformation is the result of static and/or dynamic deformation. Such a measurement system can be used, in particular, for a blade of a rotor and, for example, a blade of a main rotor of a helicopter. Indeed, the service life of a blade may be estimated as a function of the dynamic deformation experienced by this blade during use.

This measurement system may comprise one or more of the following features, taken individually or in combination with each another.

According to one possibility, the at least one chamber may be closed by at least one plug arranged in the tube and impermeable to the non-Newtonian fluid.

One or more of the chambers may be delimited longitudinally by at least one plug and radially by the tube. For example, a chamber may extend between two plugs arranged in the tube and impermeable to the non-Newtonian fluid, or between a plug and a bottom or a partition of the tube.

Moreover, the non-Newtonian fluid may comprise particles in suspension in a liquid. The volume of each chamber may be optimized so that the particles are evenly distributed in the liquid during use, in particular for use on a blade that is subject to centrifugal forces. The term “each” is used in the expression “the volume of each chamber” irrespective of whether there are several chambers or a single chamber. The same applies hereinafter in the text when the term “each” is associated with another noun.

According to one possibility compatible with the preceding possibilities, the measurement system may comprise at least one ring secured to the measurement sector and arranged in said non-Newtonian fluid, or in a chamber.

Each ring contributes to the deformation of the measurement sector in the event of dynamic deformation generating an increase in the viscosity of the non-Newtonian fluid. Indeed, each ring forms a shoulder in contact with the non-Newtonian fluid and likely to constitute an obstacle set in motion by this non-Newtonian fluid.

According to one possibility compatible with the preceding possibilities, the at least one chamber may comprise two chambers filled with the non-Newtonian fluid and arranged to either side of a said Bragg grating, the measurement sector extending into these two chambers.

A Bragg grating may therefore be positioned between two sections of the measurement sector that can be rigidly attached to the tube via the non-Newtonian fluid in the event of dynamic deformations.

Alternatively, the measurement system may comprise a single chamber, a Bragg grating being positioned between an anchoring point of the optical fiber and said chamber.

A single chamber may be sufficient to deform the Bragg grating.

According to one possibility compatible with the preceding possibilities, the Bragg grating may be arranged in said at least one chamber.

One or more Bragg gratings may be embedded in the non-Newtonian fluid.

According to one possibility compatible with the preceding possibilities, the measurement system may comprise an interrogator optically coupled to the optical fiber, the interrogator being configured to illuminate the optical fiber and to capture light reflected by the Bragg grating and deduce from this a dynamic deformation of the object.

A conventional interrogator known to a person skilled in the art may be used to emit a light beam into the optical fiber and capture the light reflected by the Bragg grating. A controller of the interrogator may be configured to calculate a dynamic deformation that has occurred, as a function of this reflected light.

According to one possibility compatible with the preceding possibilities, the measurement sector may comprise several Bragg gratings having different pitches.

Several Bragg gratings may be provided in the optical fiber, and in the measurement sector in particular, in order to monitor the dynamic deformations at various zones of the monitored object. For example, the measurement sector may comprise approximately twenty Bragg gratings. Each Bragg grating is configured to reflect light within a range of values different from the other Bragg gratings in use, in order to enable an interrogator to determine the deformations at the various zones of the object.

According to one possibility compatible with the preceding possibilities, said optical fiber may comprise a core provided with the at least one Bragg grating, the optical fiber comprising a cladding surrounding the core, the optical fiber comprising a coating surrounding the cladding, the coating having an alloy made from iron and nickel.

Such a coating helps to thermally insulate the core so that the measurements are affected little, if at all, by the outside temperature and/or the temperature of the object. Furthermore, the change in temperature may be a slow phenomenon due to slow diffusion constants. Such a change and its impact on the measured deformation can therefore be identified to accurately determine the dynamic deformation that has occurred.

Alternatively, the measurement system may be used when the temperature changes little.

According to another aspect, an aircraft provided with an object may comprise a measurement system according to the disclosure, said tube being fastened to the object or embedded in the object.

The disclosure also relates to a method implemented by such a measurement system. The disclosure thus relates to a method for measuring a dynamic deformation of an object with a measurement system comprising an optical fiber extending into a tube that is configured to be secured to said object, the optical fiber having a measurement sector that is able to move inside the tube, the measurement sector comprising at least one Bragg grating. This measurement method comprises the following steps:
a) when static deformation occurs, rendering the measurement sector automatically movable in relation to the tube in a non-Newtonian fluid in contact with the tube and the measurement sector; and
b) when dynamic deformation occurs, rigidly attaching the measurement sector to the tube with the non-Newtonian fluid, emitting light into the optical fiber, and receiving light reflected by the Bragg grating, and determining the dynamic deformation as a function of a measurement law and said reflected light.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a view of a measurement system for measuring a deformation of an object;

FIG. 2 is a view of a measurement system for measuring a deformation of an object;

FIG. 3 is a view of a measurement system for measuring a deformation of an object; and

FIG. 4 is a diagram explaining the disclosure.

### DETAILED DESCRIPTION

Elements that are present in more than one of the figures are given the same references in each of them.

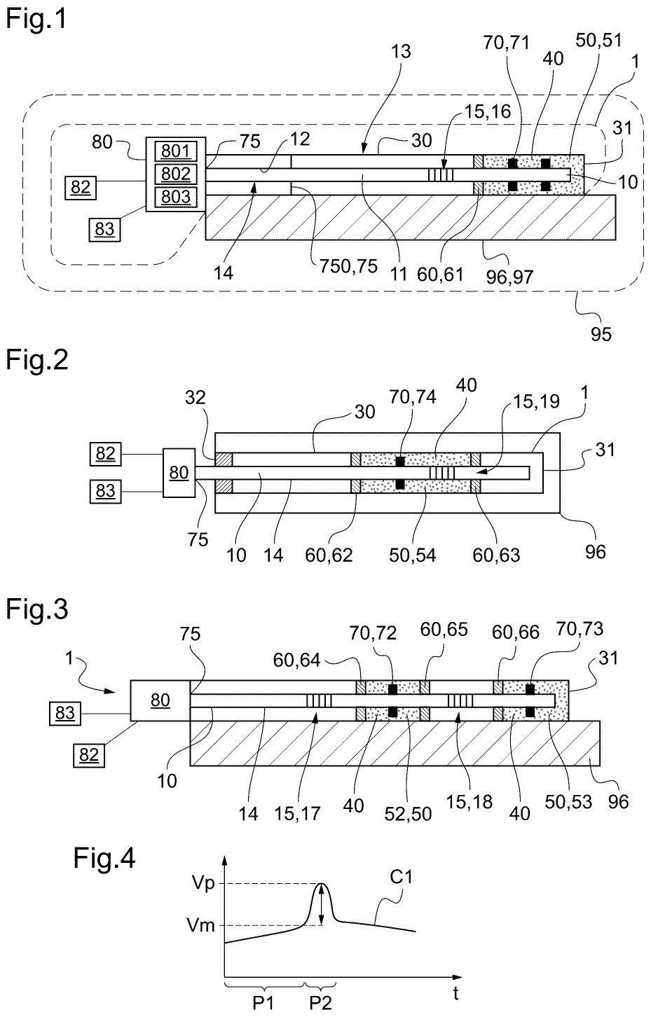

FIGS. 1 to 3 show various measurement systems 1 according to the disclosure for measuring a dynamic deformation of an object 96.

In reference to FIG. 1, and irrespective of the embodiment of the measurement system 1, this object 96 and the measurement system 1 may be arranged in an aircraft 95. For example, the object 96 may be a blade 97 of a rotor contributing at least to the lift of the aircraft 95.

The measurement system 1 comprises an optical fiber 10. The optical fiber 10 is provided with a measurement sector 14 that comprises one or more Bragg gratings 15. FIGS. 1 and 2 show an optical fiber 10 having a measurement sector 14 provided with a single Bragg grating 16, 19 whereas FIG. 3 shows an optical fiber 10 having a measurement sector 14 provided with two Bragg gratings 17, 18. When there are several Bragg gratings 15, these Bragg gratings 15 advantageously have different pitches for reflecting light at different and distinguishable wavelengths. Reference number 15 denotes any Bragg grating, and reference numbers 16 to 19 are used to denote a specific Bragg grating, if required.

Therefore, the optical fiber 10 comprises a core 11 provided with the Bragg grating or gratings 15. Each Bragg grating 15 may be formed in a conventional manner on the core 11. The optical fiber 10 also comprises a cladding 12 surrounding the core 11. The cladding 12 may be a conventional cladding designed to contain the light waves in the core 11. The optical fiber 10 may finally comprise a coating 13 that surrounds the cladding 12. This coating 13 may comprise an alloy made from iron and nickel for thermally insulating the core from the outside of the optical fiber 10, and may indeed comprise 64% iron and 36% nickel.

The optical fiber 10 extends totally, or only partially, into a tube 30. The tube 30 possibly may comprise tetrafluoroethylene. This tube 30 is secured to the object 96 by conventional means. According to the example shown in FIG. 1, the tube 30 may be adhered to a wall of the object 96. According to the example shown in FIG. 2, the tube 30 may be embedded in a thickness of the object 96.

Irrespective of the embodiment and in reference to FIG. 1, the measurement sector 14 is rendered movable inside the tube 30. The measurement sector 14 is not physically fastened to the tube 30 along its entire length and is therefore free to move inside the tube 30, and therefore in relation to the tube 30, in the absence of dynamic deformations of the tube 30.

The optical fiber 10 is also optically connected to an interrogator 80. For example, the optical fiber 10 is physically connected to the interrogator 80 at an anchoring point 75.

The tube 30 may also be connected to the interrogator 80, or may be traversed by the optical fiber 10, as shown in FIG. 2. In this case, a partition 32 may close off the end of the tube 30 traversed by the optical fiber 10 in order to prevent pollutants from entering. The other end of the tube 30 may comprise a bottom 31.

The interrogator 80 may comprise a light emitter 801 of a conventional type configured to illuminate the optical fiber 10. For example, the light emitter 801 comprises a laser diode. The interrogator 80 may comprise a receiver 802 of a conventional type for receiving light reflected by one or more of the Bragg gratings and transmitting a signal that varies as a function of the wavelength of this reflected light. Such a receiver may comprise a photodiode.

This interrogator 80 may comprise a controller 803 communicating with the receiver 802. By way of example, the controller 803 may comprise at least one processor and at least one memory, at least one integrated circuit, at least one programmable system, or at least one logic circuit, these examples not limiting the scope to be given to the term “controller”. The term “processor” may, for example, refer equally to a central processing unit or CPU, a graphics processing unit or GPU, a digital signal processor or DSP, a microcontroller, etc.

The controller 81 may be configured in a conventional manner to assess deformation of the object 96 using the signal transmitted by the receiver, a sudden variation in the deformation being the result of dynamic deformation, as explained below. For example, the controller 81 stores a measurement law providing said deformation as a function of the received signal.

The modules of the interrogator, i.e., the emitter 801 and the receiver 802 and the controller 803, may be arranged in the same housing or may be located in different locations. At least one of the modules may be situated on the object 96 or remotely.

For example, in the context of an object 96 situated in a rotating reference frame, the emitter 801 and the receiver 802 may be situated in the rotating reference frame. The controller 803 may then be arranged in the rotating reference frame, or in a stationary reference frame, being connected to the receiver 802 by a conventional transmission device such as, for example, a brush or wireless system.

The interrogator 80 and, for example, its controller 803, may be connected to a display 82 configured to display information carrying the dynamic deformation determined by this controller 803, and/or to a memory 83 capable of storing this dynamic deformation.

According to another aspect, the measurement system 1 comprises a non-Newtonian fluid 40 filling at least one chamber 50 of the tube 30. For example, the non-Newtonian fluid 40 is chosen from a shear-thickening fluid and a viscoelastic fluid, for example from a molten polymer and a mixture of cornstarch and water, that is a shear-thickening fluid. FIGS. 1 and 2 show a tube 30 having a single chamber 51, 54, whereas FIG. 3 shows two chambers 52, 53, by way of example. Reference number 50 denotes any chamber, reference numbers 51 to 54 being used for specific chambers, if required.

When there is a single chamber 50, the Bragg grating or gratings 15 may be situated between the chamber 50 and an anchoring point 75, this anchoring point 75 possibly being the point of connection of the optical fiber 10 to the interrogator 80 or being constituted by another connector 750 immobilizing the optical fiber 10 in relation to the tube 30, for example. Alternatively, at least one Bragg grating 15 may be situated in the chamber 50. If there are several chambers 50, at least one Bragg grating 15 may be situated between two chambers 50.

Irrespective of the embodiment and in reference once again to FIG. 1, the measurement sector 14 extends into each chamber 50. In a chamber 50, the non-Newtonian fluid 40 is in contact with the tube 30 and the measurement sector 14.

Moreover, at least one chamber 50 may be closed by at least one plug 60 that is arranged in the tube 30 and that is impermeable to the non-Newtonian fluid 40, or by a bottom 31 or a partition 32 of the tube 30. Reference number 60 denotes any plug, reference numbers 61 to 66 being used to denote specific plugs, if required.

Moreover, the measurement system 1 may comprise at least one ring 70 secured to the measurement sector 14 and arranged in said non-Newtonian fluid 40. For example, such a ring 70 is adhered to the measurement sector 14. For example, the measurement sector 14 comprises one ring 70 in each chamber 50. Reference number 70 denotes any ring, reference numbers 71 to 74 being used to denote specific plugs, if required.

In these conditions, FIGS. 1 to 3 show various embodiments.

According to FIG. 1, the tube 30 may be adhered to an object 96. This tube 30 accommodates a single chamber 51 filled with non-Newtonian fluid 40, this single chamber 51 being closed longitudinally by a single plug 61 and a bottom 31 of the tube 30. The measurement sector 14 extends completely into the tube 30, from the interrogator 80, through the plug 61, to the chamber 51. The measurement sector 14 also comprises a Bragg grating 16 between the chamber 51 and the interrogator 80, and a ring 71.

According to FIG. 2, the tube 30 may be embedded in the object 96. This tube 30 accommodates a single chamber 54 filled with non-Newtonian fluid 40, this single chamber 54 being closed longitudinally by two plugs 62, 63. The measurement sector 14 extends partially into the tube 30 and enters this tube 30 by passing through a partition 32. The measurement sector 14 also comprises a Bragg grating 19 arranged in the chamber 54, and a ring 74.

According to FIG. 3, the tube 30 may be adhered to an object 96. This tube 30 accommodates two chambers 52, 53 filled with non-Newtonian fluid 40. A first chamber 52 is closed longitudinally by two plugs 64, 65 and a second chamber 53 is closed longitudinally by a plug 66 and a bottom 31 of the tube 30. The measurement sector 14 extends completely into the tube 30 and extends into the two chambers 52, 53. The measurement sector 14 comprises two Bragg gratings 17, 18, i.e., a first Bragg grating 17 between the interrogator 80 and the first chamber 52, and a second Bragg grating 18 between the first chamber 52 and the second chamber 53. The measurement sector also comprises two rings 72, 73 in the first chamber 52 and the second chamber 53 respectively.

These three embodiments are provided as examples to illustrated various configurations.

Irrespective of the embodiment of a measurement system 1 according to the disclosure, FIG. 4 shows how the implemented method functions.

This FIG. 4 presents a diagram showing time on the X-axis, and the wavelength of the light reflected by a Bragg grating 15 to the interrogator 80 on the Y-axis. The curve C1 shows a variation of this wavelength.

In order to monitor the object 96, the interrogator 80 emits light into the optical fiber 10. This light is reflected at a certain wavelength by a Bragg grating 15. The receiver 802 of the interrogator captures this reflected light and transmits a conventional signal to the controller 803 of the interrogator 80. This is used by the controller 803 to deduce a deformation that has occurred.

If the object 96 experiences static deformation, the tube 30 tends to be deformed. In this case, the non-Newtonian fluid 40 deforms the optical fiber 10 a little, or not at all. The measurement sector 14 is automatically rendered movable in relation to the tube 30 due to the viscosity of the non-Newtonian fluid 40. The value of the wavelength of the reflected light varies little during this period P1. The deformation determined by the controller varies little or not at all. The controller 803 can deduce from this that the object 96 is not experiencing dynamic deformation, for example as long as the variation in the determined deformation is less than a deformation threshold, and can transmit this information to a memory 83 or to the display 82.

During another period P2, the object 96 experiences dynamic deformation. In this case, the method involves the measurement sector 14 being rigidly attached to the tube 30 due to the increasing viscosity of the non-Newtonian fluid 40. The optical fiber 10 is deformed at at least one Bragg grating 15. The wavelength of the reflected light increases sharply. The deformation determined by the controller varies greatly from an average value Vm to a peak Vp. The controller 803 may be configured to determine the dynamic deformation that has occurred. For example, if the variation in the determined deformation is greater than or equal to the deformation threshold, the dynamic deformation is equal to the variation in the calculated deformation in relation to an average value, from a predetermined time.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A measurement system for measuring a dynamic deformation of an object, the measurement system comprising an optical fiber, the optical fiber extending at least partially into a tube that is configured to be secured to the object, the optical fiber having a measurement sector that is able to move inside the tube, the measurement sector comprising at least one Bragg grating,
wherein the measurement system comprises a non-Newtonian fluid filling at least one chamber delimited by the tube, the measurement sector extending into the at least one chamber, the non-Newtonian fluid being in contact with the tube and the measurement sector, the measurement system comprising at least one ring secured to the measurement sector and arranged in the non-Newtonian fluid.

2. The measurement system according to claim 1,
wherein the at least one chamber is closed by at least one plug arranged in the tube and impermeable to the non-Newtonian fluid.

3. The measurement system according to claim 1,
wherein the at least one ring is arranged in the chamber.

4. The measurement system according to claim 1,
wherein the at least one chamber comprises two chambers filled with the non-Newtonian fluid and arranged to either side of the Bragg grating, the measurement sector extending into these two chambers.

5. The measurement system according to claim 1,
wherein the measurement system comprises a single chamber, the Bragg grating being positioned between an anchoring point of the optical fiber and the single chamber.

6. The measurement system according to claim 1,
wherein the Bragg grating is arranged in the at least one chamber.

7. The measurement system according to claim 1,
wherein the measurement system comprises an interrogator optically coupled to the optical fiber, the interrogator being configured to illuminate the optical fiber and to capture light reflected by the Bragg grating and deduce from this a dynamic deformation of the object.

8. The measurement system according to claim 1,
wherein the measurement sector comprises several Bragg gratings having different pitches.

9. The measurement system according to claim 1,
wherein the optical fiber comprises a core provided with the at least one Bragg grating, the optical fiber comprising a cladding surrounding the core, the optical fiber comprising a coating surrounding the cladding, the coating having an alloy made from iron and nickel.

10. The measurement system according to claim 1,
wherein the non-Newtonian fluid is a shear-thickening fluid or a viscoelastic fluid.

11. An aircraft provided with an object,
wherein the aircraft comprises the measurement system according to claim 1, the tube being fastened to the object or embedded in the object.

12. A method for measuring a dynamic deformation of an object with the measurement system according to claim 1 comprising an optical fiber extending into a tube that is configured to be secured to the object, the optical fiber having a measurement sector that is able to move inside the tube, the measurement sector comprising at least one Bragg grating, the non-Newtonian fluid rendering the measurement sector automatically movable in relation to the tube when static deformation occurs, the non-Newtonian fluid rigidly attaching the measurement sector to the tube when dynamic deformation occurs,
the measurement method comprising, when dynamic deformation occurs, emitting light into the optical fiber, and receiving light reflected by the Bragg grating, and determining the dynamic deformation as a function of a measurement law and the reflected light.
